(19) United States
(12) Patent Application Publication
(10) Pub. No.: US 2007/0253221 A1
(43) Pub. Date: Nov. 1, 2007

(54) Backlight module and liquid crystal display having same

(75) Inventors: Cheng-Feng Tsai, Miao-Li (TW); Cheng-Hsien Yu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/796,812

(22) Filed: Apr. 30, 2007

(30) Foreign Application Priority Data
Apr. 28, 2006 (TW) 95115391

(51) Int. Cl. F21V 7/04

(52) U.S. Cl. 362/633

(57) ABSTRACT

An exemplary backlight module (20) includes an optical film assembly (22) having at least two optical films, each optical film having at least one ear (221) attached together; a frame (24) having at least one concave groove (243) receiving the at least one ear.

### FIELD OF THE INVENTION

The present invention relates to backlight modules, and especially to a backlight module for liquid crystal display (LCD) devices and a method for fabricating a backlight module.

### BACKGROUND

Liquid crystal displays are commonly used as display devices for compact electronic apparatuses, because they not only provide good quality images with little power but also are very thin. The liquid crystals in a liquid crystal display do not emit any light themselves. The liquid crystals have to be lit by a light source so as to clearly and sharply display text and images. Thus, a backlight module for an LCD is generally needed.

FIG. 8 is a partially schematic, cross-sectional, assembly view of a typical liquid crystal display (LCD), and FIG. 9 is a schematic, partially, exploded view of the LCD of FIG. 8. The LCD has a liquid crystal panel 11, a plurality of optical films 12, a light guide plate 13, a reflector 14, a bottom frame 15, and a bezel 16. The liquid crystal panel 11, the plurality of optical films 12, the light guide plate 13 and the reflector 14 are disposed on the bottom frame 15 in that order, from top to bottom. The bottom frame 15 is configured for a rectangular structure, which is used to accommodate the plurality of optical films 12, the light guide plate 13 and the reflector 14. The bezel 16 is fixed on the bottom frame 15 for fixing the above-described optical elements and exposing an active region of the liquid crystal panel 11.

Each optical film 12 has a corresponding ear 121, which extend from sidewalls of each optical film 12. Each ear 121 has an opening 122 in a center region therein.

The bottom frame 15 has a plurality of grooves 151 corresponding to the plurality of ears 121 of the optical films 12, and a plurality of fixing elements 153. The plurality of grooves 151 is respectively formed at two sidewalls thereof. Each groove 151 has a fixing pole 152, which corresponds to the opening 122. When the optical films 12 are assembled at the bottom frame 15, each fixing pole 152 drills through the corresponding opening 122 of the optical films 12. The fixing elements 153 are configured to an L-shaped structure, which has a horizontal portion 1531 and a vertical portion 1532 perpendicular to the horizontal portion 1531. The horizontal portion 1531 has a through hole 154 in a center region thereof.

In assembly, the grooves 151 of the bottom frame 15 accommodates the ears 121 of the plurality of optical films 12. The fixing poles 152 respectively drill through the corresponding openings 122 for fixing the plurality of optical films 12. The fixing elements 153 respectively clip the optical films 12 at the grooves 151 and the fixing poles 152 respectively drill through the through hole 154 of the fixing elements 153.

However, the fixing poles 152 are easy to be distorted and become unstable when the bottom frame 15 is subjected to vibration or shock in the process of assembly or transportation. Thus, the optical films 122 are easy to be damaged for friction produced therebetween. Therefore, the optical characteristic of the LCD is decreased.

What is needed, therefore, is a backlight module in which the optical films thereof are compactly and stably assembled together, preferably without any gaps therebetween.

### SUMMARY

An exemplary backlight module includes an optical film assembly having at least two optical films, each optical film having at least one ear attached together; a frame having at least one concave groove receiving the at least one ear.

An exemplary method for fabricating a backlight module having steps of: providing optical elements for a backlight module, comprising a plurality of optical films, each optical film including at least one ear extending outward from sidewall of each optical film, the corresponding ears of the plurality of optical films being attached together; and accommodating the optical elements in a frame, the frame having at least one concave groove receiving the corresponding ears.

An exemplary liquid crystal display includes a liquid crystal panel; and a backlight module for providing light beams to the liquid crystal panel. The backlight module has an optical film assembly having at least two optical films, each optical film having at least one ear, the corresponding ears of the optical film assembly being attached together; and a frame having at least one concave groove receiving the at least one ear.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of a backlight module according to a first embodiment of the present invention;

FIG. 2 is a partially, enlarged view of a portion II of FIG. 1;

FIG. 3 is an assembled view of the backlight module of FIG. 1;

FIG. 4 is a partially, enlarged view of an ear of an optical films of a backlight module according to a second embodiment of the present invention;

FIG. 5 is a flow chart of a method for assembling a backlight module, which has a plurality of optical films;

FIG. 6 is a schematic view of an optical film used in the method of FIG. 5;

FIG. 7 is a schematic view showing a process of assembling the plurality of optical films;

FIG. 8 is an exploded, isometric view of a conventionally backlight module; and

FIG. 9 is a partially, enlarged, exploded, isometric view of the backlight module of FIG. 8.

### DETAILED DESCRIPTION OF PREFERRED EMBODIMENTS

Reference will now be made to the drawings to describe the preferred embodiments in detail.

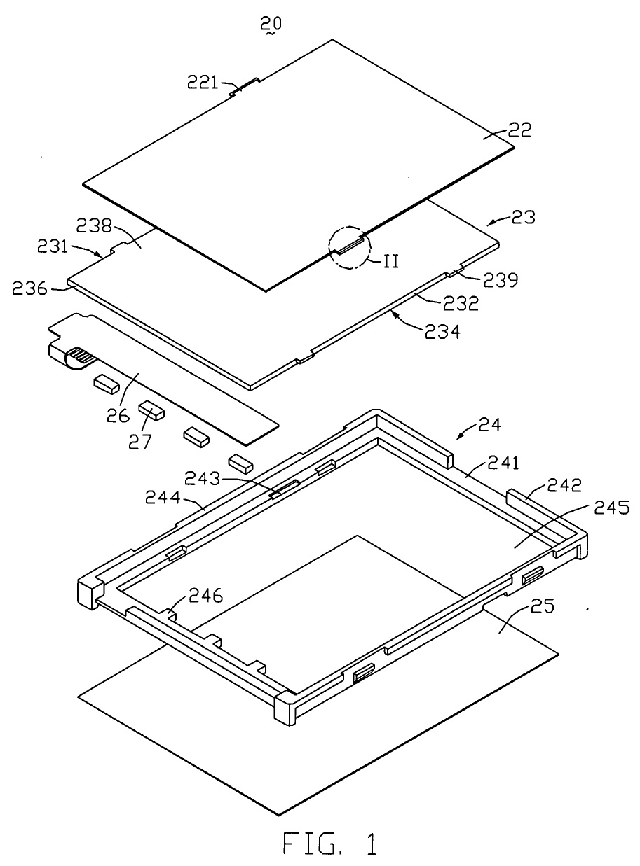

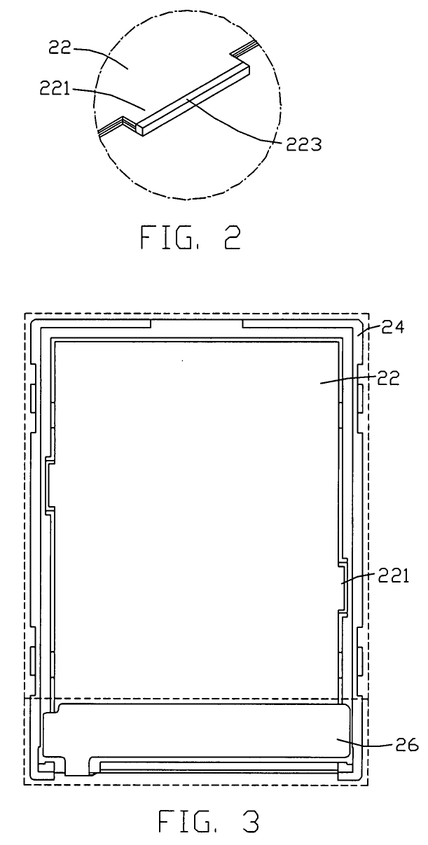

FIG. 1 is an exploded, isometric view of a backlight module according to a first embodiment of the present invention. The backlight module 20 includes an optical film assembly 22, a light guide plate 23, a plastic frame 24, a reflective film 25 arranged in that order.

The optical film assembly 22 is formed by a plurality of optical films integrated together, such as diffuser, brightness enhance film (BEF) etc. The optical film assembly 22 has two corresponding ears 221 extending from two opposite sides of the optical film assembly 22, respectively. Each ear 221 are integrated together through a fixing glue 223 adhering the peripheral five sides of the corresponding ear 221.

The light guide plate 23 includes a light incident surface 236, a light emitting surface 238, a bottom surface 234, a first side surface 231, and a second side surface 232. The light emitting surface 238 is perpendicularly connected with the light incident surface 236. The bottom surface 234 is on an opposite side of the light guide plate 23 to the light emitting surface 238. The first side surface 231 and the second side surface 232 are on opposite sides of the light guide plate 23 to each other, and are perpendicularly connected with the light incident surface 236, the light emitting surface 238, and the bottom surface 234. That is, the light incident surface 236, the first side surface 231, and the second side surface 232 are positioned between the light emitting surface 238 and the bottom surface 234. Four ears 239 are respectively extend outward from the first and the second sidewalls 231, 232. In the illustrated embodiment, the ears 239 have a top portion coplanar with the light emitting surface 238, and are half as thick as the main body of the light guide plate 23.

The frame 24 has a substantially rectangular shape, and includes two first side walls 242 located opposite to each other, two second side walls 244 located opposite to each other, and a supporting board 241. The first side walls 242 and the second side walls 244 are connected end to end, and first side walls 242 are essentially perpendicular to the second side walls 244. The supporting board 241 is generally frame-shaped, and integrally adjoins inner surfaces (not labeled) of the first side walls 242 and the second side walls 244. Thus the frame 24 defines a generally rectangular space (not labeled) for accommodating the light guide plate 23 and supporting the liquid crystal panel (not shown). Six concave grooves 243 are respectively formed at the supporting board 241 for respectively accommodating the ears 221, 239 of the optical films 22 and the light guide plate 23. Three protrusions 246 are formed adjacent to one of the first side walls 242 at the supporting board 241. The protrusions 246 extend into the space, and are parallel to each other, thereby defining four recesses (not labeled).

The backlight module 20 further includes a circuit board 26, and four light emitting diodes (LED) 27 arranged on the circuit board 26. The circuit board 26 can be a flexible printed circuit (FPC) or a printed circuit board (PCB), and provides power for the LEDs 27. The LEDs 27 are respectively positioned in the recesses, adjacent to the light incident surface 236 of the light guide plate 23. The circuit board 26 is adjacent to the light guide plate 23 at the light incident surface 236, with part of the circuit board 26 overlapping the light emitting surface 238.

FIG. 3 is an assembled view of the backlight module 2. The reflector 25, the light guide plate 23 and the optical film assembly 22 are orderly accommodated in a space 245 surrounded by the frame 24. The ears 221, 239 of the optical film assembly 22 and the light guide plate 23 are respectively accommodated in corresponding concave grooves 243. In addition, the LEDs 27 are disposed are respectively positioned in the recesses, adjacent to the light incident surface 236 of the light guide plate 23. The circuit board 26 is adjacent to the light guide plate 23 at the light incident surface 236, with part of the circuit board 26 overlapping the light emitting surface 238.

The backlight module 20 utilize the fixing glue 223 attaching the plurality of optical films to the optical film assembly 22 and the concave groove 243 receiving the ears 221 integrated by the fixing glue 223. Thus, with the above-described configurations, when the backlight module is assembled, the optical films are fixed to the frame 24 by the ears 221 and the concave grooves 243. This means that the optical film assembly 22 of the optical film assembly 22 can be prevented from being damaged by the distortion of the conventional fixing poles 152 even when the backlight module 20 is subjected to vibration or shock during operation or transportation. Thus, reliability of the backlight module 20 is improved, and optical performance of the backlight module 20 is both improved and maintained.

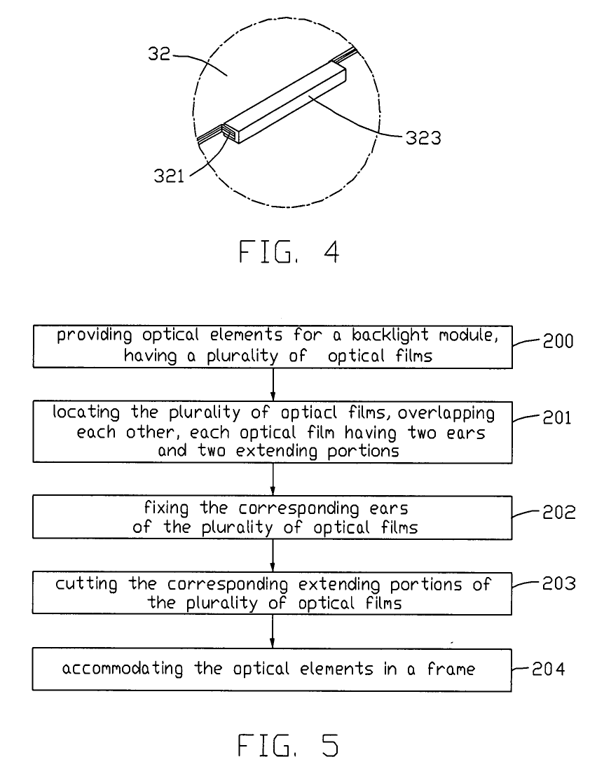

Referring to FIG. 4, an optical film assembly of a backlight module according to a second embodiment of the present invention is shown. The optical film assembly 32 has a similar structure to the optical film assembly 22 except that a plurality of ears 321 of the optical film assembly 32 are attached together by an elastic plastic sleeve, which clips three sides of the plurality of ears 321 to fix the optical films together.

FIG. 7 is a flow chart of a method for manufacturing the backlight module 20. The method includes processes of: step 200, providing optical elements for a backlight module, having a plurality of optical films; step 201, locating the plurality of optical films, overlapping each other, each optical film having two ears and two extending portions; step 202, fixing the corresponding ears of the plurality of optical films; step 203, cutting the extending portions of the plurality of optical films; and step 204 accommodating the optical elements in a frame.

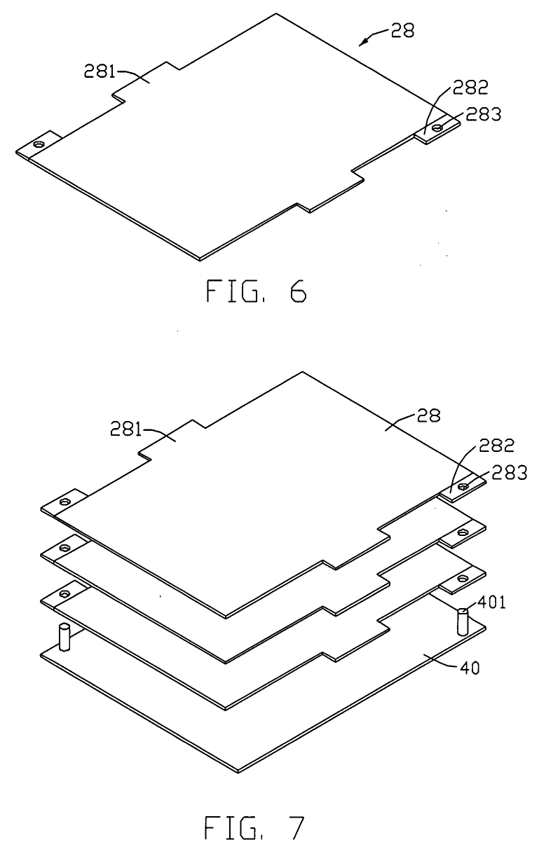

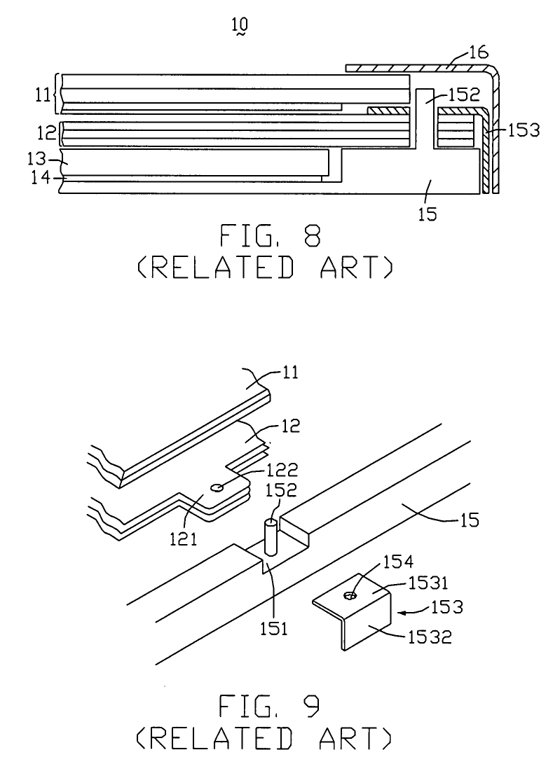

In step 200, optical elements for a backlight module are provided, which includes a plurality of optical films 28 (as shown in FIG. 6), a light guide plate, and a reflector. Each optical film 28 has two extending portions 282 and two ears 281. The two extending portions 282 and the two ears 281 respectively extend from two opposite sides of the optical film 28. Each extending portion 282 has a locating hole 283.

In step 201, the plurality of optical films 28 are disposed at a locating device 40 (as shown in FIG. 7). The locating device 40 has a similar size to the optical films 28, which has a plurality of locating poles 401 corresponding to the locating holes 283 of the optical films 28. The plurality of optical films 28 are disposed at the locating device 40 through the locating poles 401 drilling through the locating holes 283. Thus, the plurality of optical films 28 is located together, overlapping each other.

In step 202, the plurality of optical films 28 are fixed together through a fixing element attaching the ears 281. The fixing method can be adhering peripheral five sides of the ears 281 through glue, or using an elastic sleeve clipping the peripheral three sides of the ears 281.

In step 203, the plurality of extending portions 282 are cut for making the plurality of optical films 28 have an appropriate size to the other optical elements.

In step 204, the optical elements are received in a frame to form a backlight module, the frame having at least one concave groove receiving the corresponding ears.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemlary embodiments of the invention.

What is claimed is:

1. A backlight module, comprising:
an optical film assembly having at least two optical films, each optical film having at least one ear, the corresponding ears of the optical film assembly being attached together; and
a frame having at least one concave groove receiving the at least one ear.

2. The backlight module as claimed in claim 1, further comprising a light guide plate accommodated in the frame, the optical film assembly being disposed at the light guide plate.

3. The backlight module as claimed in claim 1, further comprising a light source disposed adjacent to one side of the light guide plate.

4. The backlight module as claimed in claim 1, wherein the corresponding ears of the optical film assembly are attached together through a fixing means.

5. The backlight module as claimed in claim 4, wherein the fixing means is glue adhering the peripheral sides of the corresponding ears.

6. The backlight module as claimed in claim 4, wherein the fixing means is an elastic sleeve clipping the peripheral sides of the corresponding ears.

7. The backlight module as claimed in claim 1, wherein the frame comprises two first side walls located opposite to each other, and two second side walls located opposite to each other, and a supporting board.

8. The backlight module as claimed in claim 7, wherein the supporting board is generally frame-shaped, and integrally adjoins inner surfaces of the first side walls and the second side walls.

9. The backlight module as claimed in claim 8, wherein at least one concave grooves is formed at the supporting board for respectively accommodating the at least one ear of the optical films.

10. A method for fabricating a backlight module comprising steps of:
providing optical elements for a backlight module, comprising a plurality of optical films, each optical film comprising at least one ear extending outward from sidewall of each optical film, the corresponding ears of the plurality of optical films being attached together; and
accommodating the optical elements in a frame, the frame having at least one concave groove receiving the corresponding ears.

11. The method as claimed in claim 10, further comprising locating the plurality of optical films, overlapping each other, each optical film further comprising at least one extending portion extending outward from sidewall of each optical film.

12. The method as claimed in claim 11, further comprising cutting the plurality of corresponding extending portions of the plurality of optical films;

13. The method as claimed in claim 12, wherein the plurality of optical films is located at a locating device.

14. The method as claimed in claim 13, wherein the locating device comprises at least one fixing pole, and each extending portion having a through hole therein.

15. The method as claimed in claim 14, wherein the plurality of optical films is located thereat through the fixing pole of the locating device drilling through the through hole of the optical films.

16. The method as claimed in claim 10, wherein the corresponding ears are fixed through glue adhering the peripheral sides of the corresponding ears.

17. The method as claimed in claim 10, wherein the corresponding ears are fixed through an elastic sleeve clipping the peripheral sides of the corresponding ears.

18. A liquid crystal display comprising:
a liquid crystal panel; and
a backlight module for providing light beams to the liquid crystal panel, which comprises:
an optical film assembly having at least two optical films, each optical film having at least one ear, the corresponding ears of the optical film assembly being attached together; and
a frame having at least one concave groove receiving the at least one ear.
